(19) United States
(12) Patent Application Publication
(10) Pub. No.: US 2026/0093144 A1
(43) Pub. Date: Apr. 2, 2026

(54) LIGHT-EMITTING MODULE AND MOBILE DEVICE

(71) Applicant: Nichia Corporation, Anan-shi (JP)

(72) Inventor: Norimasa YOSHIDA, Komatsushima-shi (JP)

(21) Appl. No.: 19/331,698

(22) Filed: Sep. 17, 2025

(30) Foreign Application Priority Data
Sep. 27, 2024 (JP) 2024-168587
Aug. 26, 2025 (JP) 2025-140560

(51) Int. Cl. G02F 1/13357; G02F 1/167

(52) U.S. Cl. CPC G02F 1/133605; G02F 1/133621; G02F 1/167

(57) ABSTRACT

A light-emitting module includes a housing including a first opening, a substrate including a second opening, a light-emitting device, and electronic paper covering the first opening. The light-emitting device is disposed in the housing and configured to emit first light. At least a portion of second light, which is a reflective component of the first light reflected by the electronic paper, is emitted to outside of the housing through the second opening. The electronic paper is switchable between a first state in which a first color appears when the light-emitting device is turned on and a second state in which a second color appears when the light-emitting device is turned off. In the first state and the second state, the electronic paper is visually recognizable from the outside of the housing through the second opening.

### CROSS-REFERENCE TO RELATED APPLICATION

This application claims priority to Japanese Patent Application No. 2024-168587 filed on Sep. 27, 2024, and Japanese Patent Application No. 2025-140560 filed on Aug. 26, 2025. The disclosures of these applications are hereby incorporated by reference in their entireties.

### BACKGROUND

### Technical Field

Embodiments relate to a light-emitting module and a mobile device.

### Background Art

An LED and a flash module that controls light emitted from the LED are mounted in a mobile device such as a smartphone, and an optical element such as a Fresnel lens is disposed on a light-emitting surface side of the LED (for example, see Japanese Patent Publication No. 2014-060283 and Japanese Patent Publication No. 2016-081872).

It is preferable for a mobile device such as a smartphone to have a flash that looks less conspicuous.

However, because a Fresnel shape is widely adopted, the appearance of the flash becomes whitish. In a case in which the color of the mobile device case surrounding the light-emitting portion of the flash does not match the appearance color of the flash, the appearance of the flash becomes conspicuous.

### SUMMARY

Embodiments have been made in view of the above-described issues, and an object is to provide a light-emitting module and a mobile device in which a difference in color between the appearance of a light-emitting portion such as a flash when turned off and a mobile device case around the light-emitting portion of the flash is reduced so that they look less conspicuous.

A light-emitting module according to an embodiment includes: a housing including a first opening; a substrate including a second opening; a light-emitting device disposed in the housing and configured to emit first light; and electronic paper covering the first opening. At least a portion of second light, which is a reflective component of the first light reflected by the electronic paper, is emitted to outside of the housing through the second opening. The electronic paper is switchable between a first state in which a first color appears when the light-emitting device is turned on and a second state in which a second color appears when the light-emitting device is turned off. In the first state and the second state, the electronic paper is visually recognizable from the outside of the housing through the second opening.

A mobile device according to an embodiment includes a case and the above-described light-emitting module disposed in the case.

According to the embodiments, a light-emitting module and a mobile device in which an appearance of a light-emitting portion such as a flash is made less conspicuous can be provided.

### BRIEF DESCRIPTION OF DRAWINGS

FIG. 1A schematically illustrates a front view of a light-emitting module according to a first embodiment;

FIG. 1B schematically illustrates a plan view of a light-emitting module according to the first embodiment, a second embodiment, a third embodiment, a fourth embodiment, and a fifth embodiment when an electronic paper or a dimming mirror is viewed from the outside of the light-emitting module;

FIG. 1C schematically illustrates a cross-sectional view of the light-emitting module according to the first embodiment taken along line C-C in FIG. 1A;

FIG. 1D schematically illustrates a cut end view, showing only a cut surface along line D-D in FIG. 1B, of the light-emitting module according to the first embodiment;

FIG. 1E schematically illustrates a bottom view of the light-emitting module according to the first embodiment as viewed from a light-transmissive member side;

FIG. 2 schematically illustrates an example of a structure of the electronic paper;

FIG. 3 illustrates relative intensity of light emitted from an LED and then transmitted through a liquid crystal panel in a white color expression state;

FIG. 4 illustrates the relative intensity of light emitted from the LED and then reflected by the electronic paper in a white color expression state;

FIG. 5 schematically illustrates a cut end view, showing only a cut surface along line D-D in FIG. 1B, of a light-emitting module according to a first modified example of the first embodiment;

FIG. 6 schematically illustrates a cut end view, showing only a cut surface along line D-D in FIG. 1B, of a light-emitting module according to a second modified example of the first embodiment;

FIG. 7A schematically illustrates a cross-sectional view of a light-emitting module according to the second modified example of the first embodiment taken along line C-C in FIG. 1A;

FIG. 7B schematically illustrates a cross-sectional view of a light-emitting module according to a third modified example of the first embodiment taken along line C-C in FIG. 1A;

FIG. 7C schematically illustrates a cross-sectional view of a light-emitting module according to a fourth modified example of the first embodiment taken along line C-C in FIG. 1A;

FIG. 8 schematically illustrates a cut end view, showing only a cut surface along line D-D in FIG. 1B, of a light-emitting module according to a fifth modified example of the first embodiment;

FIG. 9A schematically illustrates a cut end view, showing only a cut surface along line D-D in FIG. 1B, of a light-emitting module according to a second embodiment;

FIG. 9B schematically illustrates a cut end view, showing only a cut surface along line D-D in FIG. 1B, of a light-emitting module according to a first modified example of the second embodiment showing only a cut surface;

FIG. 9C schematically illustrates cut end view, showing only a cut surface along line D-D in FIG. 1B, of a light-emitting module according to a second modified example of the second embodiment taken;

FIG. 9D schematically illustrates a cut end view, showing only a cut surface along line D-D in FIG. 1B, of a light-emitting module according to a third modified example of the second embodiment;

FIG. 10A schematically illustrates a cut end view, showing only a cut surface along line D-D in FIG. 1B, of a light-emitting module according to a third embodiment;

FIG. 10B schematically illustrates a cut end view, showing only a cut surface along line D-D in FIG. 1B, of a light-emitting module according to a first modified example of the third embodiment;

FIG. 10C schematically illustrates a cut end view, showing only a cut surface along line D-D in FIG. 1B, of a light-emitting module according to a second modified example of the third embodiment;

FIG. 11A schematically illustrates a cut end view, showing only a cut surface along line D-D in FIG. 1B, of a light-emitting module according to a fourth embodiment;

FIG. 11B schematically illustrates a cut end view, showing only a cut surface along line D-D in FIG. 1B, of a light-emitting module according to a first modified example of the fourth embodiment;

FIG. 11C schematically illustrates a cut end view, showing only a cut surface along line D-D in FIG. 1B, of a light-emitting module according to a second modified example of the fourth embodiment;

FIG. 12 schematically illustrates a cut end view, showing only a cut surface along line D-D in FIG. 1B, of a light-emitting module according to a fifth embodiment; and

FIG. 13 schematically illustrates a perspective view of a mobile device according to the embodiments.

### DETAILED DESCRIPTION

Certain embodiments of the present invention will be described below with reference to the drawings.

### 1. Light-Emitting Module

### First Embodiment

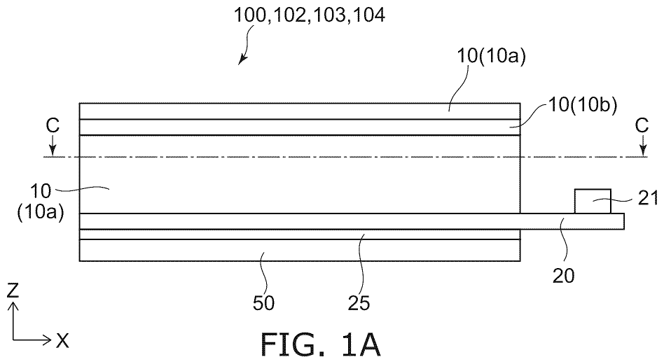

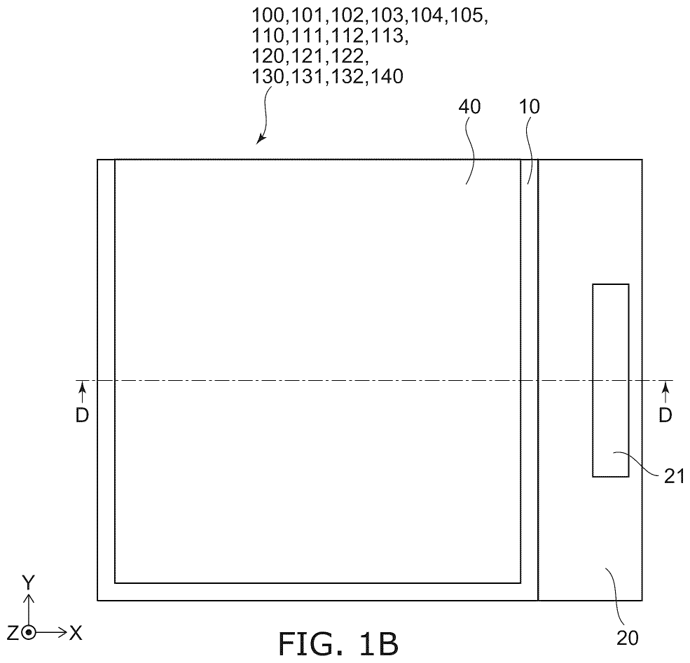

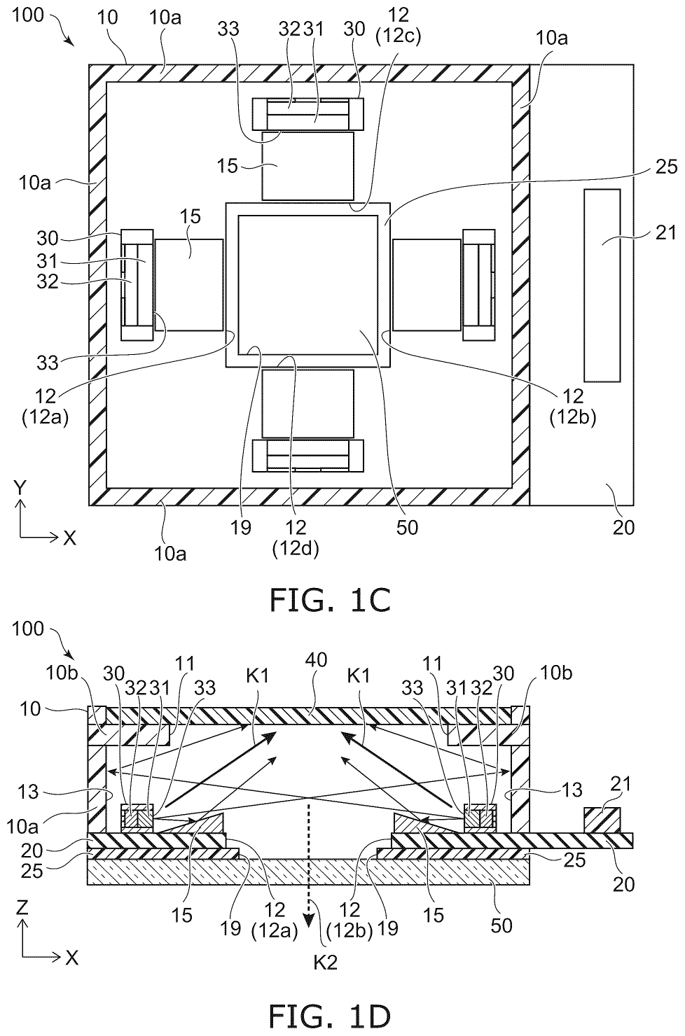

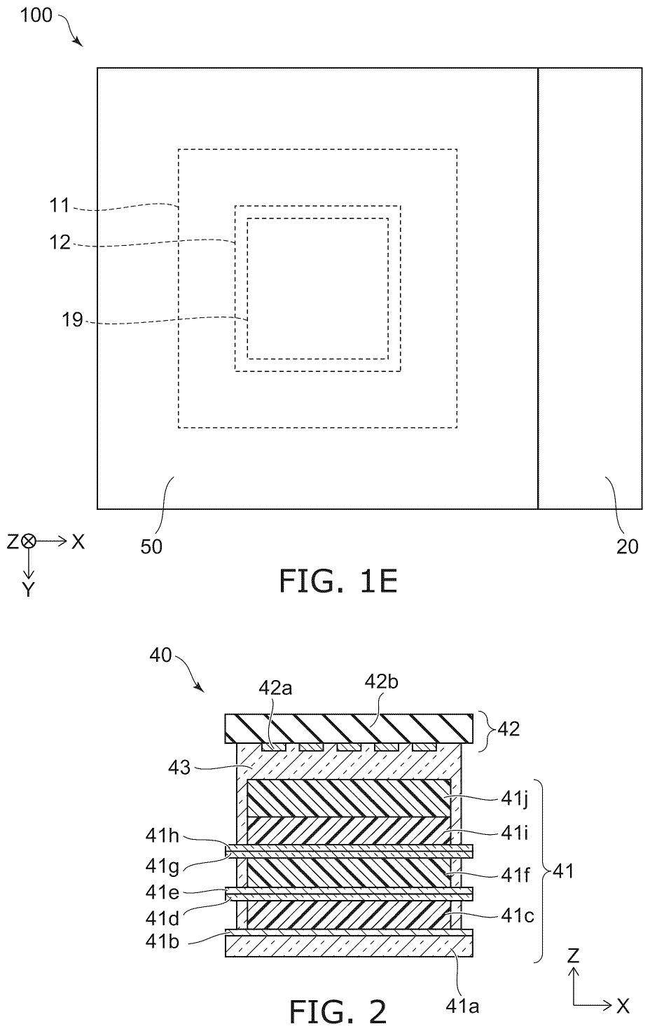

First, the first embodiment will be described. FIG. 1A schematically illustrates a front view of a light-emitting module 100 according to the first embodiment. FIG. 1B schematically illustrates a plan view of the light-emitting module 100 according to the first embodiment when viewed from above, and the plan view is a view when the electronic paper 40 is viewed from the outside of the light-emitting module 100. FIG. 1C schematically illustrates a cross-sectional view taken along line C-C in FIG. 1A. FIG. 1D schematically illustrate a cut end view showing only a cut surface along line D-D in FIG. 1B. FIG. 1E illustrates a bottom view of the light-emitting module 100 according to the first embodiment as viewed from below the light-emitting module 100, that is, as viewed from a light-transmissive member 50 side. As illustrated in FIGS. 1A, 1B, 1C, 1D, and 1E, the light-emitting module 100 according to the first embodiment includes a housing 10, a substrate 20, a light-emitting device 30, and electronic paper 40. The light-emitting module 100 according to the first embodiment is, for example, a flash or the like. The following describes each configuration.

As illustrated in FIG. 1D, the housing 10 includes a side portion 10a extending upward (in +Z direction) from the substrate 20 and having an angular tubular shape surrounding an outer periphery as shown in FIG. 1C. Further, the housing 10 includes an upper portion 10b disposed between the side portion 10a in contact with the substrate 20 and a side portion 10a in contact with the electronic paper 40 and extending toward the inside of the housing 10. The housing 10 is formed of a material made of resin, metal, or a combination thereof, and is preferably formed of a light-reflective material. The housing 10 includes a first opening 11. The first opening 11 is formed in an upper portion of the housing 10 and is formed by the upper portion 10b. The second opening 12 of the substrate 20 that will be described below is formed in a lower portion of the housing 10. A size of the second opening 12 is smaller than a size of the first opening 11. Alternatively, the size of the second opening 12 may be larger than that of the first opening 11. A direction from a side 12a to a side 12b of the second opening 12 is defined as a +X direction (direction indicated by an arrow of an X axis) and a direction opposite thereto is defined as a-X direction, a direction from a side 12d to a side 12c of the second opening 12 is defined as a +Y direction (direction indicated by an arrow of a Y axis) and a direction opposite thereto is defined as a-Y direction, and a direction from the second opening 12 to the first opening 11 is defined as a +Z direction (direction indicated by an arrow of a Z axis) and a direction opposite thereto is defined as a-Z direction.

A reflector 15 that reflects first light K1 emitted from the light-emitting device 30 toward the electronic paper 40, which will be described below, is provided in the housing 10. The reflector 15 is provided on the substrate 20 and is located between the light-emitting device 30 and the second opening 12 in the X direction. The reflector 15 has a triangular shape in a cut end view as illustrated in FIG. 1D in order to efficiently reflect the first light K1 toward the electronic paper 40 and is arranged such that an oblique side faces an emission surface 33 of the light-emitting device 30.

The housing 10 may be constituted by the same material, or the material of the housing 10 on the outer side and the material on the inner side thereof may be constituted by different materials, and it is preferable that the material on the inner side which is at least the inner surface of the housing 10 be a first light-reflective member 13. The first light-reflective member 13 is not limited as long as the first light-reflective member 13 can reflect the first light K1 emitted from the light-emitting device 30, and is preferably made of a white resin. When the housing 10 is a light-reflective member, the first light K1 of the light-emitting device 30 is efficiently reflected.

The light-emitting device 30 is disposed on the substrate 20. Also, the housing 10 is disposed on the substrate 20, and the substrate 20 is bonded to the housing 10 via a bonding member. The substrate 20 is, for example, a printed wiring substrate. The second opening 12 is formed in the substrate 20. The second opening 12 is located, in the housing 10, at a side opposite to a side of the first opening 11. A connector 21 for connecting a power supply or the like is provided outside the housing 10, and the connector 21 is disposed on the substrate 20.

The light-emitting module 100 according to the first embodiment may further include an adjustment member 25. The adjustment member 25 is provided between the substrate 20 and a light-transmissive member 50. The adjustment member 25 adjusts an emission area or the like of second light K2 reflected by the electronic paper 40. The adjustment member 25 is constituted of, for example, resin, metal, or a combination thereof. A third opening 19 may be formed in the adjustment member 25. The third opening 19 may have a rectangular shape or a circular shape. The adjustment member 25 is bonded to the substrate 20 and the light-transmissive member 50 by a connection member such as a double-sided tape, an acrylic adhesive, or an epoxy adhesive. The connection member is not illustrated in the drawings.

The light-emitting device 30 is disposed in the housing 10 at a position surrounded by the housing 10 and is disposed on the substrate 20. The light-emitting device 30 includes a wavelength conversion member 31 containing a phosphor and a light-emitting element 32. The phosphor may be a red phosphor (hereinafter simply referred to as R) and a green phosphor (hereinafter simply referred to as G). The light-emitting element 32 is a blue light-emitting element (hereinafter simply referred to as B). The light-emitting device 30 emits the first light K1 of a color expressed by RGB light.

The emission surface 33 of the light-emitting device 30 faces in the direction toward the inside of the housing 10. The emission surface 33 of the light-emitting device 30 may face in a direction toward the first opening 11. The light-emitting device 30 emits the first light K1 toward the electronic paper 40.

In a case in which the light-emitting module 100 is used for a flash, for example, the first light K1 is preferably white. White light may be obtained by a combination of a blue light-emitting element, a green phosphor, and a red phosphor; a blue light-emitting element and a yellow phosphor; a blue light-emitting element, a green light-emitting element, and a red phosphor; or a red light-emitting element, a blue light-emitting element, and a green light-emitting element.

As illustrated in FIG. 1C, a plurality of the light-emitting devices 30 are provided on the substrate 20, each of the plurality of the light-emitting devices 30 being disposed between a respective one of sides 12a, 12b, 12c, and 12d of the second opening 12 and the side portion 10a. The emission surfaces 33 of two of the light-emitting devices 30, each of the two being disposed between a respective one of the sides 12a and 12b and the side portion 10a, are arranged so as to face each other in the +X direction and the −X direction. The emission surfaces 33 of two of the light-emitting devices 30, each of the two being disposed between a respective one of the sides 12c and 12d and the side portion 10a, are arranged so as to face each other in the +Y direction and the −Y direction. All of the emission surfaces 33 face a region above the second opening 12. Further, the second opening 12 has a rectangular shape, such as an elongated rectangular shape. In the present embodiment, for example, four light-emitting devices 30 and four reflectors 15 are disposed. Each of the reflectors 15 is disposed at a location outward of a respective one of the sides 12a, 12b, 12c, and 12d of the second opening 12 between a respective one of the light-emitting devices 30 and the second opening 12. The number of the light-emitting devices 30 is not limited to four, as illustrated in FIG. 1C, and may be one or more.

The electronic paper 40 is disposed to cover the first opening 11. The electronic paper 40 is substantially flat. The electronic paper 40 reflects the first light K1 emitted from the light-emitting device 30 such that the second light K2, which is a reflective component of the first light K1, travels to the outside of the housing 10 through the second opening 12. The second light K2 refers to light obtained as a result of reflection by the electronic paper 40.

Examples of the electronic paper 40 include structures such as an electrochemical system (electrochromic), an electrophoretic system, a particle rotation system, a particle movement system, a twisting ball system, a cholesteric liquid crystal system, an MEMS system, and the like, and a reflective LCD. However, the electronic paper 40 is not limited to these systems as long as the electronic paper 40 can reflect the first light K1. The following describes a configuration of the electronic paper 40.

FIG. 2 schematically illustrates an example of a structure of the electronic paper 40. The electronic paper 40 is described by taking an electrochromic system as an example.

As illustrated in FIG. 2, the electronic paper 40 includes a display unit 41 and a driving unit 42 in this order from a lower side (−Z side) and includes an electrolyte 43 provided therebetween. For the display unit 41, a transparent substrate 41a, a first electrode 41b, a magenta layer 41c, a first insulating layer 41d, a second electrode 41e, a yellow layer 41f, a second insulating layer 41g, a third electrode 41h, a cyan layer 41i, and a reflective layer 41j are laminated in this order from the bottom. The transparent substrate 41a is a transparent substrate and transmits the first light K1 emitted from the light-emitting device 30. The first electrode 41b, the second electrode 41e, and the third electrode 41h are transparent electrodes. The first insulating layer 41d and the second insulating layer 41g are transparent insulating layers. The driving unit 42 includes counter electrodes 42a and a circuit substrate 42b. The reflective layer 41j is selected from white and black. Color expression can be performed, since the electronic paper 40 includes the magenta layer 41c, the yellow layer 41f, the cyan layer 41i, and the reflective layer 41j.

Each of the magenta layer 41c, the yellow layer 41f, and the cyan layer 41i is constituted with a titanium-oxide nanoparticle film carrying an electrochromic compound, and charges are injected/extracted using the titanium-oxide nanoparticles as sensitized electrodes to perform a redox reaction of the electrochromic compound at a high speed. The color-expression state once achieved is maintained even when supply of electricity is stopped.

As the electrochromic compound, a known compound is used, and examples thereof include inorganic oxides such as tungsten oxide and iridium oxide, metal-complex compounds represented by Prussian blue, conductive polymer compounds, viologen compounds, leuco dye-based compounds, and organic compounds such as terephthalic acid compounds.

The operation of the light-emitting module 100 according to the first embodiment will be described. The first light K1 emitted from the light-emitting device 30 travels toward the electronic paper 40 and is reflected by the electronic paper 40 and a reflective component of the first light K1 becomes the second light K2. At least a portion of the second light K2 can be emitted to the outside of the housing 10 through the second opening 12. Electronic paper 40 is switchable between a first state in which a first color appears when the light-emitting device 30 is turned on and a second state in which a second color appears when the light-emitting device 30 is turned off, by the configuration illustrated in FIG. 2. The first state and the second state refer to a color-presentation state. In the first state, the second light K2, which becomes the first color when the light-emitting device 30 is turned on, is emitted to the outside of the housing 10 through the second opening 12. In the second state, the electronic paper 40, which becomes the second color (, which may or may not be the same as the first color) when the light-emitting device 30 is turned off, is visually recognizable from the outside of the housing 10. Various color expressions can be achieved in the first state and the second state, as will be described below.

The color of the first state and the color of the second state are selected from cyan, magenta, yellow, white, red, green, black, blue, and a mixed color of two or more of the above colors. The light-emitting module 100 is used for, for example, a flash, and accordingly the color in the first state is preferably white.

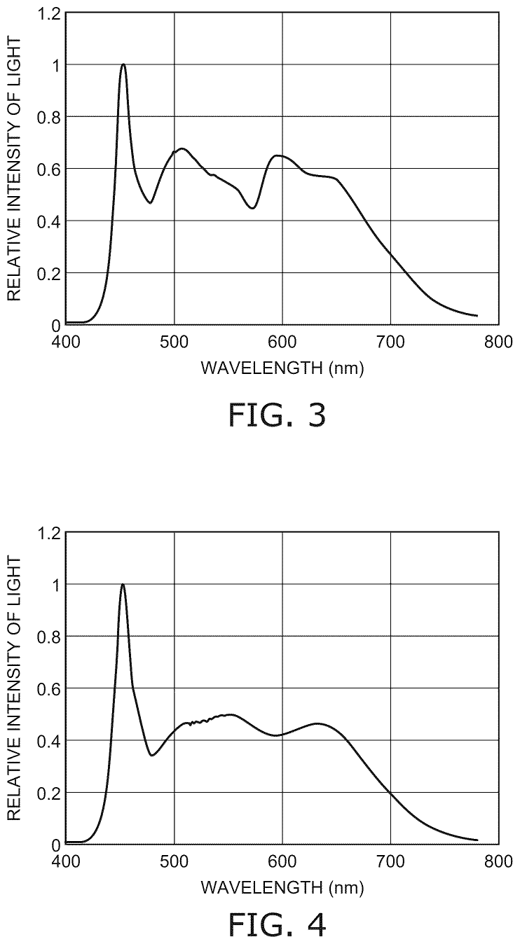

Effects of the light-emitting module 100 according to the first embodiment will be described below. If the first light K1 emitted from the light-emitting device 30 is not reflected by the electronic paper 40 but is transmitted through, for example, a liquid crystal panel including a color filter and the second light K2 emitted to the outside of the housing 10 is white light, the wavelengths have a relative intensity distribution as illustrated in FIG. 3. In contrast, in the light-emitting module 100 according to the present embodiment, when the first light K1 emitted from the light-emitting device 30 is reflected by the electronic paper 40 and the second light K2 emitted to the outside of the housing 10 is white light, the wavelengths have a relative intensity distribution as illustrated in FIG. 4. As a result, as illustrated in FIG. 3, a general color rendering index Ra of the second light K2 that is emitted to the outside of the housing 10 as white light after being transmitted through the liquid crystal panel is approximately 92, and the general color rendering index Ra of the second light K2 that is emitted to the outside of the housing 10 as white light after being reflected by the electronic paper 40, as illustrated in FIG. 4, is as high as 97. The second light K2 having a high general color rendering index Ra can be emitted to the outside of the housing 10, and when used for the purpose of a camera flash, color rendering of the subject can be improved. In the first state in which the first color appears when the light-emitting device 30 is turned on, in a case in which the light-emitting module 100 according to the present embodiment reflects the first light K1 emitted from the light-emitting device 30 by the electronic paper 40 and emits the second light K2 to the outside of the housing 10, various emission colors can be achieved by setting the electronic paper 40 to the above-described color, and high color rendering performance can be further obtained.

The electronic paper 40 is visually recognizable from the outside of the housing 10 through the second opening 12 in the first state and the second state. For example, when the light-emitting module 100 according to the present embodiment is viewed from a light-transmissive member 50 side as illustrated in FIG. 1E, the electronic paper 40 is visually recognizable from the outside of the housing 10. In a case in which the light-emitting module 100 according to the present embodiment is used in mobile devices such as a smartphone or a tablet, in the second state in which the second color appears when the light-emitting device 30 is turned off, the appearance of the light-emitting portion such as a flash can be made less conspicuous by setting the expressed color of the electronic paper 40 to match a color to that of the case around the flash light-emitting portion of the mobile device.

The following will describe preferred embodiments, modified examples, and other embodiments of the present embodiments.

When the light-emitting device 30 is disposed at a position away from the second opening 12 and on a side of the side portion 10a of the housing 10, the light-emitting device 30 is not visually recognizable from the outside of the housing 10 through the second opening 12. That is, the light-emitting device 30 is not visually recognizable from the outside of the light-transmissive member 50 in the cut end view in FIG. 1D. In this way, the appearance of the light-emitting portion such as a flash or the like can be made less conspicuous.

The light-emitting module 100 according to the first embodiment further includes the light-transmissive member 50 having a flat plate shape. The light-transmissive member 50 is disposed to cover the second opening 12. The light-transmissive member 50 is formed of light-transmissive acrylic, polycarbonate, glass, or the like. With such a configuration, entry of foreign matter into the housing 10 can be reduced. The light-transmissive member 50 is bonded to the substrate 20 or the adjustment member 25 by disposing the connection member such as a double-sided tape, an acrylic adhesive, or an epoxy adhesive at a position that does not interfere with emission of the second light K2.

By changing the size of the second opening 12, an amount of the second light K2 can be adjusted. Also, by changing the shape of the second opening 12, a shape in which the second light K2 is emitted to the outside of the housing 10 can be changed. For example, in a plan view, when the shape of the second opening 12 is a circular shape, the shape of light emitted as the second light K2 to the outside of the housing 10 can be close to a circular shape, and when the shape of the second opening 12 is a square or rectangular shape, the shape of light emitted as the second light K2 to the outside of the housing 10 is close to a square or rectangular shape.

The light-emitting module 100 according to the first embodiment can adjust the color of the second light K2 by changing the expressed color of the electronic paper 40 in the second color.

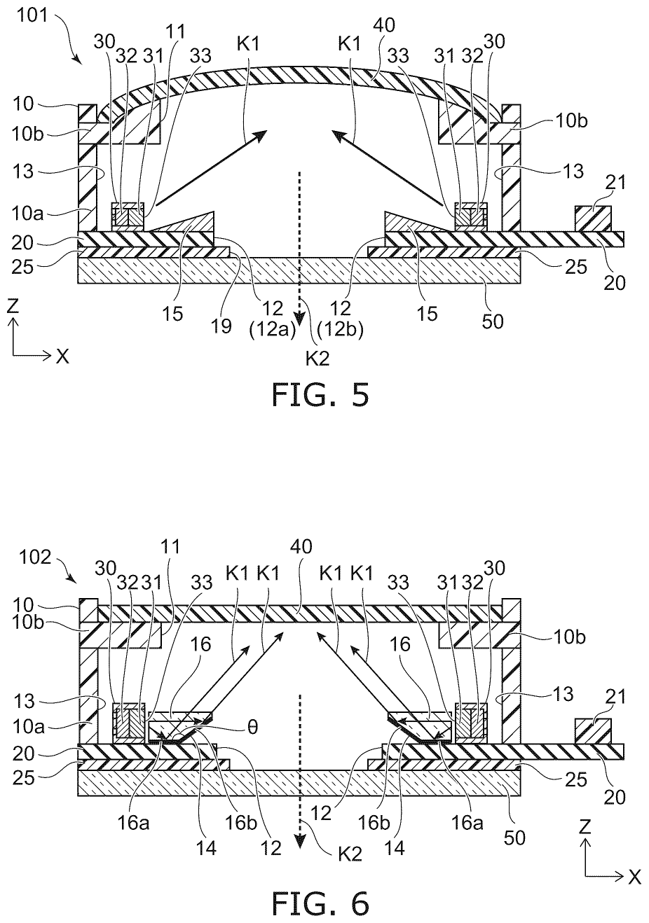

FIG. 5 schematically illustrates a cut end view, showing only a cut surface along line D-D in FIG. 1B, of a light-emitting module 101 according to a first modified example of the first embodiment. Preferably, the electronic paper 40 is curved in a convex shape in a direction from the second opening 12 toward the first opening 11, as illustrated in FIG. 5. With this structure, the first light K1 from the light-emitting device 30 can be efficiently reflected by the electronic paper 40, and the second light K2 can be emitted to the outside of the housing 10. The configurations, operations, and effects other than those described above in the present modified example are the same as those of the light-emitting module 100 according to the first embodiment.

FIG. 6 schematically illustrates a cut end view, showing only a cut surface along line D-D in FIG. 1B, of a light-emitting module 102 according to a second modified example of the first embodiment. The light-emitting module 102 according to the second modified example of the first embodiment is different from the light-emitting module 100 according to the first embodiment in that the shape of a reflector 16 is different and the reflector 16 includes a second light-reflective member 14. In the light-emitting module 102 according to the second modified example of the first embodiment, as illustrated in FIG. 6, the second light-reflective member 14 is provided on the reflector 16 formed of a light-transmissive base material, and the second light-reflective member 14 is a part of the reflector 16. The second light-reflective member 14 is not provided on a surface of the reflector 16 facing the emission surface 33 of the light-emitting device 30 and closest to the emission surface 33, but is provided on a surface of the reflector 16 connected to the substrate 20 via a bonding member, and further on a surface of the reflector 16 continuous with the surface connected to the substrate 20 via the bonding member and close to the second opening 12. The second light-reflective member 14 may be formed by attaching a reflective sheet to the reflector 16, or by applying a light-reflective liquid to the reflector 16 and drying the liquid. In this case, the reflector 16 has transmissivity. At least a portion of the first light K1 can be efficiently reflected to the electronic paper 40 by the second light-reflective member 14. Further, the second light-reflective member is not necessarily provided. Because the reflector 16 is formed of the light-transmissive base material, total reflection of light occurs on a surface on which the second light-reflective member is to be provided, so that the reflector 16 can be used as a reflector.

As illustrated in FIG. 6, the reflector 16 preferably has, for example, a pentagonal shape in a cross-sectional view, and has a reflection angle θ formed by a surface 16a where the reflector 16 is connected to the substrate 20 via the bonding member and a surface 16b extending from the surface 16a toward the inside and the upward direction (+Z direction) of the housing 10. The reflection angle θ is in a range from 135° to 179°, preferably in a range from 145° to 170°. With this configuration, the second light-reflective member 14 can cause the first light K1 to efficiently travel to the electronic paper 40.

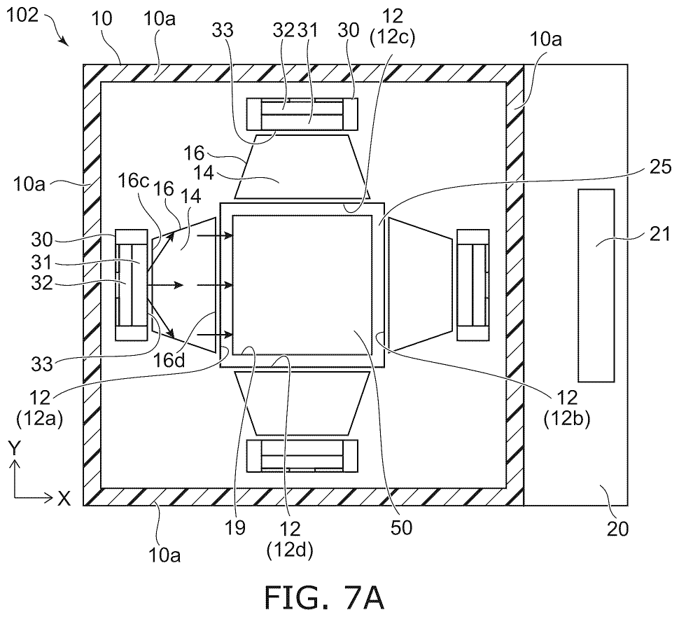

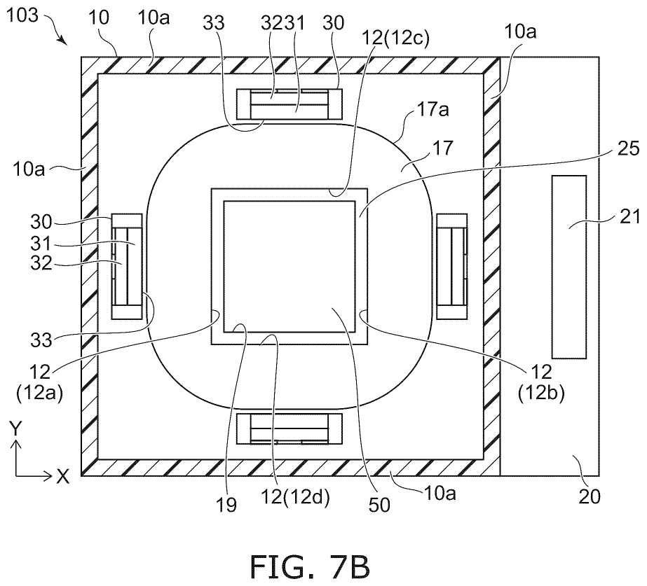

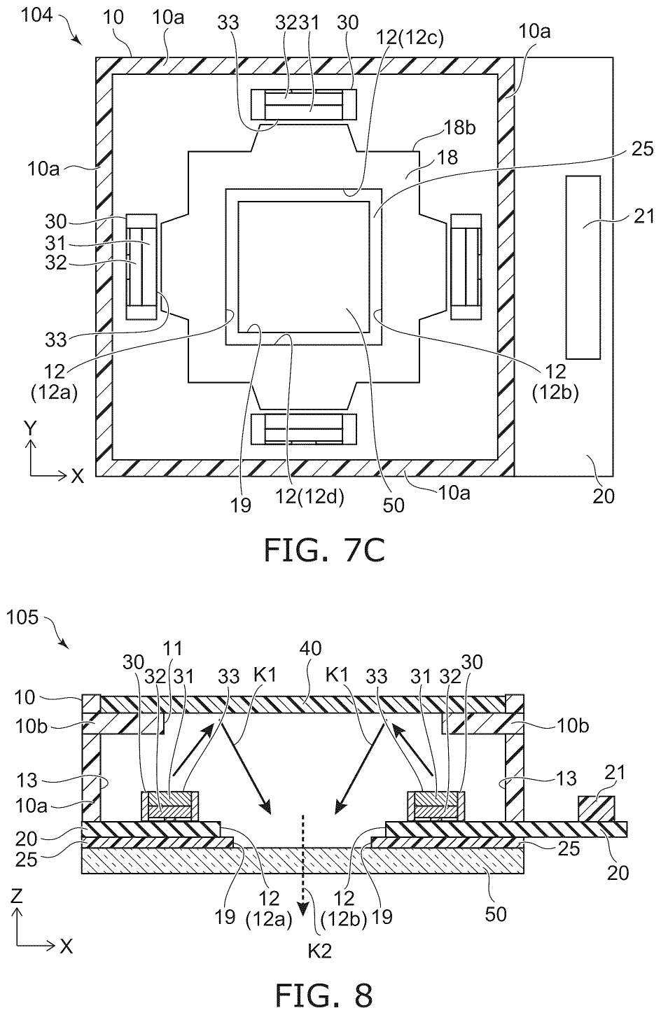

FIG. 7A schematically illustrates a cross-sectional view of the light-emitting module 102 according to the second modified example of the first embodiment taken along line C-C in FIG. 1A. As illustrated in FIG. 7A, the reflector 16 preferably has a trapezoidal shape in a plan view. When a side of the reflector 16 having a trapezoidal shape in a plan view on a light-emitting device 30 side is an upper base 16c and a side close to the second opening 12 is a lower base 16d, the lower base 16d is longer than the upper base 16c. With this configuration, since the first light K1 emitted from the light-emitting device 30 easily spreads, the second light-reflective member 14 can cause the first light K1 to efficiently travel to the electronic paper 40.

FIG. 7B schematically illustrates a cross-sectional view of a light-emitting module 103 according to a third modified example of the first embodiment taken along line C-C in FIG. 1A. As illustrated in FIG. 7B, a reflector 17 is provided so as to surround the second opening 12 in a plan view, and curved portions 17a are provided at four corners of the reflector 17, and provision of the curved portions at the four corners can facilitate reflection of light at the curved portions 17a toward the electronic paper 40. The reflector 17 is in contact with the light-emitting device 30. With the reflector 17 in contact with the light-emitting device 30, the diffusion of the first light K1 can be reduced. Further, by using the reflector 17 illustrated in FIG. 7B, the reflector 17 can be manufactured by integral molding, and the manufacturing cost can be reduced.

FIG. 7C schematically illustrates a cross-sectional view of a light-emitting module 104 according to a fourth modified example of the first embodiment taken along line C-C in FIG. 1A. As illustrated in FIG. 7C, a reflector 18 is provided to surround the second opening 12 in a plan view, and corner portions 18b may be provided at four corners of the reflector 18. The reflector 18 is in contact with the light-emitting device 30. With the reflector 18 being in contact with the light-emitting device 30, the diffusion of the first light K1 can be reduced and the first light K1 can be efficiently emitted to the electronic paper 40. By employing the reflector 18 illustrated in FIG. 7C, the reflector 18 can be manufactured by integral molding, and the manufacturing cost can be reduced.

FIG. 8 schematically illustrates a cut end view, showing only a cut surface along line D-D in FIG. 1B, of a light-emitting module 105 according to a fifth modified example of the first embodiment. As illustrated in FIG. 8, in the light-emitting module 105 according to the fifth modified example of the first embodiment, the light-emitting device 30 is disposed such that the emission surface 33 of the light-emitting device 30 is oriented upward and toward the electronic paper 40. In other words, the first light K1 is emitted in the upward direction (+Z direction), passes through and is reflected within the housing 10, and is reflected by the electronic paper 40. Thus, the second light K2 obtained as a result of reflection by the electronic paper 40 can be emitted to the outside of the housing 10. In order to efficiently irradiate the electronic paper 40 with the light emitted from the light-emitting device 30, an optical member such as a condensing lens or a TIR lens or a deflection angle member may be disposed above a light-emitting device 30. The optical axes of the light-emitting device 30 and the optical member may be offset from each other to adjust the emission direction toward a central portion of the electronic paper 40.

### Second Embodiment

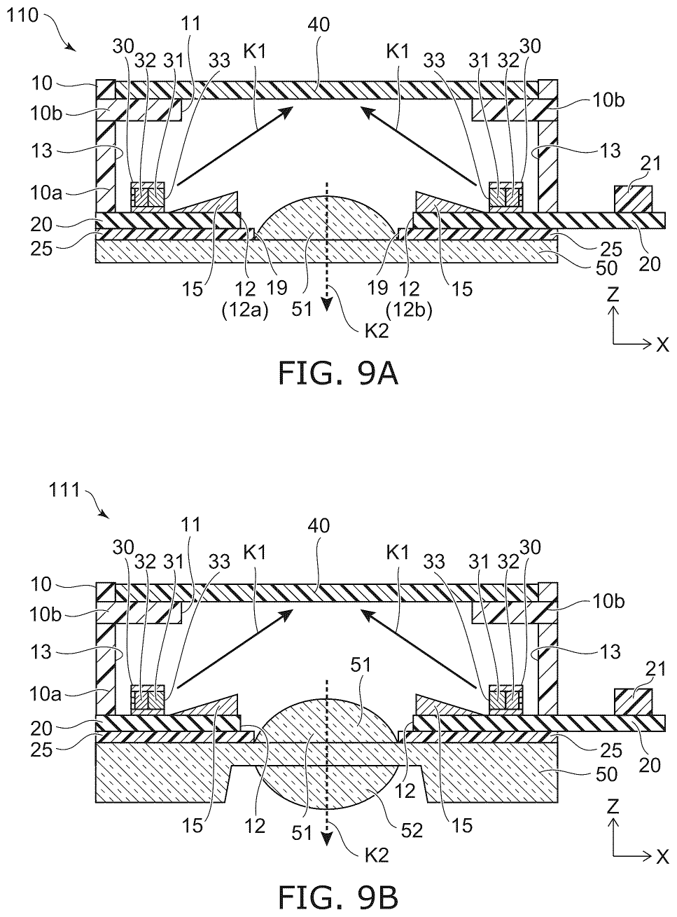

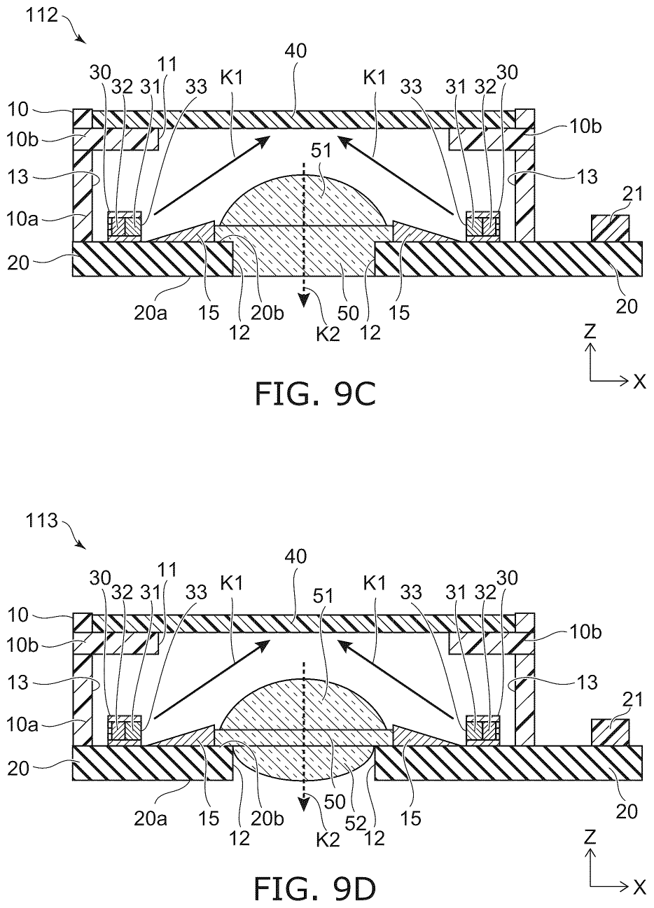

FIG. 9A schematically illustrates a cut end view, showing only a cut surface along line D-D in FIG. 1B, of a light-emitting module 110 according to the second embodiment taken along line D-D in FIG. 1B. The light-emitting module 110 according to the second embodiment has certain characteristics around a second opening 12 of a light-transmissive member 50. The light-emitting module 110 according to the second embodiment includes a plate-shaped light-transmissive member 50 and further includes a lens portion 51. Although the light-transmissive member 50 and the lens portion 51 are preferably integrally molded together, the light-transmissive member 50 and the lens portion 51 may be separate components, and the light-transmissive member 50 and the lens portion 51 may be connected together via a light-transmissive connection member. The light-transmissive member 50 illustrated in FIGS. 9A and 9B to be described below is disposed on a lower side (−Z side) of a substrate 20 and an adjustment member 25 via a bonding member such as a double-sided tape, an acrylic adhesive, or an epoxy adhesive. The lens portion 51 illustrated in FIG. 9A is disposed on an upper side (+Z side) of the light-transmissive member 50 and is curved in a convex shape in a direction from the second opening 12 toward a first opening 11. With this configuration, second light K2 reflected by electronic paper 40 can be optically controlled, and the light distribution can be adjusted so that the light can be emitted to the outside of a housing 10. Further, the emission surface located on a lower surface of the light-transmissive member 50 can be flat, the light-emitting module 110 according to the second embodiment can be installed without modification. The lens portion 51 may have a concavely curved shape in a direction from the first opening 11 toward the second opening 12. The light-transmissive member 50 is formed of light-transmissive acrylic, polycarbonate, glass, or the like. With this structure, entry of foreign matter into the housing 10 can be reduced. The curvature and size of the lens can be adjusted depending on the desired light distribution.

FIG. 9B schematically illustrates a cut end view, showing only a cut surface along line D-D in FIG. 1B, of a light-emitting module 111 according to a first modified example of the second embodiment. The light-emitting module 111 according to the first modified example of the second embodiment illustrated in FIG. 9B includes the lens portion 51 curved in a convex shape in a direction from the second opening 12 toward the first opening 11 on an upper side (+Z side) of the light-transmissive member 50, and a lens portion 52 curved in a convex shape in a direction from the first opening 11 toward the second opening 12 on a lower side (−Z side) of the light-transmissive member 50. With this structure, the second light K2 obtained as a result of reflection by the electronic paper 40 can be more optically controlled, and the light distribution can be adjusted so that emission to the outside of the housing 10 can be achieved. In the light-emitting module 111 according to the first modified example of the second embodiment, the lens portion 52 is provided on an emission surface side of the second light K2 in addition to the lens portion 51 provided on an incident surface side of the second light K2, thereby increasing optical control surfaces and further improving optical controllability. The lens portions 51 and 52 may have a concavely curved shape. Similarly, the lens portions 51 and 52 may have a concavely curved shape in FIGS. 9C and 9D to be described below. The curvature and size of the lens can be adjusted depending on the desired light distribution.

FIG. 9C schematically illustrates a cut end view, showing only a cut surface along line D-D in FIG. 1B, of a light-emitting module 112 according to a second modified example of the second embodiment. The light-emitting module 112 according to the second modified example of the second embodiment illustrated in FIG. 9C includes the light-transmissive member 50 and the lens portion 51. The light-transmissive member 50 illustrated in FIG. 9C is disposed at a position on the upper side (+Z side) relative to an upper surface 20b from a lower surface 20a of the substrate 20. The lens portion 51 illustrated in FIG. 9C is disposed on the upper side (+Z side) of the light-transmissive member 50, and is curved in a convex shape in a direction from the second opening 12 toward the first opening 11. In this way, the second light K2 obtained as a result of reflection by the electronic paper 40 can be more optically controlled, and the light distribution can be adjusted so that emission to the outside of the housing 10 can be achieved. The curvature and size of the lens can be adjusted depending on the desired light distribution. Further, because the emission surface positioned on the lower surface of the light-transmissive member 50 can be flat, the light-emitting module 112 according to the second modified example of the second embodiment can be installed without modification. Further, an amount of resin of the light-transmissive member 50 and the lens portion 51 can be reduced. Although the light-transmissive member 50 and the lens portion 51 are preferably integrally molded together, the light-transmissive member 50 and the lens portion 51 may be separate components, and the light-transmissive member 50 and the lens portion 51 may be connected to each other via a light-transmissive connection member.

FIG. 9D schematically illustrates a cut end view, showing only a cut surface along line D-D in FIG. 1B, of a light-emitting module 113 according to a third modified example of the second embodiment. The light-emitting module 113 according to the third modified example of the second embodiment illustrated in FIG. 9D includes the lens portion 51 convexly curved in a direction from the second opening 12 toward the first opening 11 on the upper side (+Z side) of the light-transmissive member 50, and the lens portion 52 convexly curved in a direction from the first opening 11 toward the second opening 12 on the lower side (−Z side) of the light-transmissive member 50. The light-transmissive member 50 is disposed at a position above the upper surface 20b of the substrate 20 (+Z side). In this way, the second light K2 obtained as a result of reflection by the electronic paper 40 can be more optically controlled, and the light distribution can be adjusted so that emission to the outside of the housing 10 can be achieved. The curvature and size of the lens can be adjusted depending on the desired light distribution. In the light-emitting module 113 according to the third modified example of the second embodiment, the lens portion 52 is also provided on the emission surface side of the second light K2 in addition to the lens portion 51 provided on the incident surface side of the second light K2, thereby increasing the optical control surfaces and further improving the optical controllability. Further, an amount of resin of the light-transmissive member 50 and the lens portion 51 can be reduced. Note that, although the light-transmissive member 50 and the lens portions 51 and 52 are preferably integrally molded together, the light-transmissive member 50 and the lens portions 51 and 52 may be separate components, and the light-transmissive member 50 and the lens portions 51 and 52 may be connected via a light-transmissive connection member.

The light-emitting modules 110, 111, 112, and 113 according to the second embodiment can adjust an emission range of the second light K2 to the outside of the housing 10 by changing a display range of the electronic paper 40 through shaping the lens portions 51 and 52 to adjust curvature and form an image. Further, the light-emitting modules 110, 111, 112, and 113 according to the second embodiment can perform partial irradiation by changing the display range of the electronic paper 40. The light-emitting modules 110, 111, 112, and 113 according to the second embodiment can perform screen display like a projector by displaying an image on the electronic paper 40, and can be used in a display device.

The configurations, operations, and effects in the second embodiment, the first modified example of the second embodiment, the second modified example of the second embodiment, and the third modified example of the second embodiment other than those described above are similar to those of the light-emitting module 100 according to the first embodiment.

### Third Embodiment

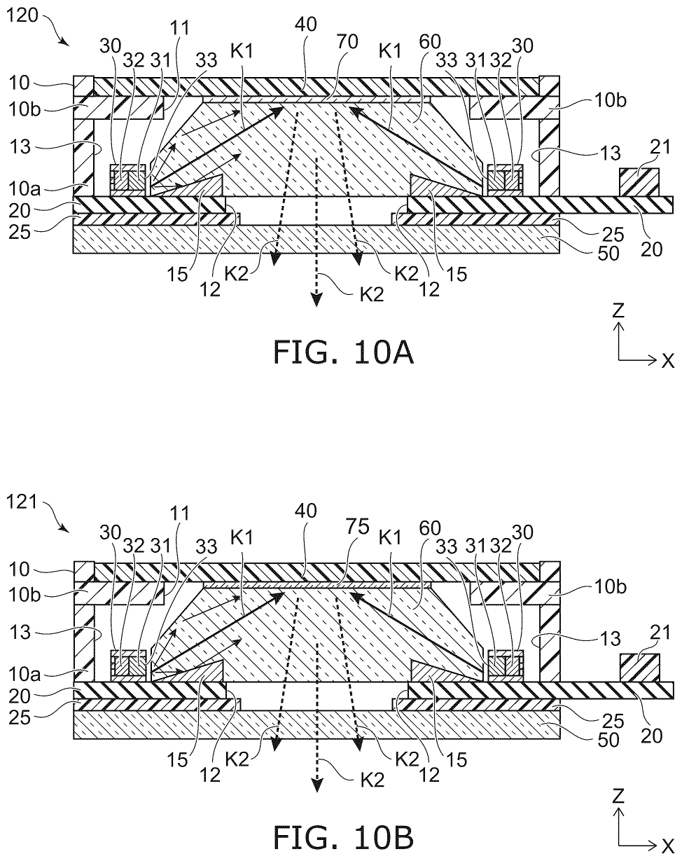

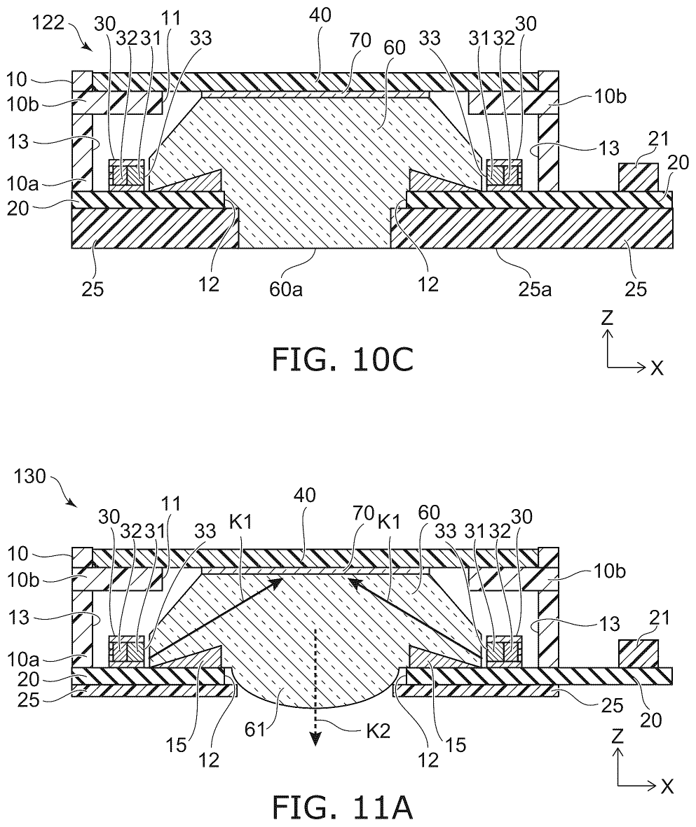

FIG. 10A schematically illustrates a cut end view, showing only a cut surface along line D-D in FIG. 1B, of a light-emitting module 120 according to the third embodiment. The light-emitting module 120 according to the third embodiment further includes a light guide member 60 disposed between a light-emitting device 30 and electronic paper 40 in a housing 10. The light guide member 60 is formed of light-transmissive acrylic, polycarbonate, glass, or the like. By providing the light guide member 60, first light K1 from the light-emitting device 30 can be efficiently emitted to the electronic paper 40, and second light K2 reflected by the electronic paper 40 can be more efficiently emitted to the outside of the housing 10. The light-emitting module 120 according to the third embodiment includes a light-transmissive adhesive member 70 disposed between the light guide member 60 and the electronic paper 40 for bonding the electronic paper 40 and the light guide member 60. Examples of the adhesive member 70 include a light-transmissive double-sided tape, and the like. By providing the adhesive member 70 between the light guide member 60 and the electronic paper 40, generation of an air layer can be reduced, so that the diffusion of the first light K1 and the second light K2 can be reduced. That is, the second light K2 can be efficiently emitted to the outside of the housing 10. Note that the light-emitting module 120 according to the third embodiment also includes a reflector 15 in the housing 10. On the other hand, in another example, the reflector 15 is not provided in the housing 10, and in that case, the first light K1 may be totally reflected and optically controlled by a difference in refractive index from air.

FIG. 10B schematically illustrates a cut end view, showing only a cut surface along line D-D in FIG. 1B, of a light-emitting module 121 according to a first modified example of the third embodiment. The light-emitting module 121 according to the first modified example of the third embodiment illustrated in FIG. 10B further includes an anti-reflective film 75 that covers a surface of the light guide member 60 facing the electronic paper 40. The anti-reflective film 75 is provided between an upper portion of the light guide member 60 and the electronic paper 40. With this configuration, the diffusion of the first light K1 and the second light K2 can be reduced, and the second light K2 obtained as a result of reflection by the electronic paper 40 can be clearly emitted to the outside of the housing 10, so that the second light K2 obtained as a result of reflection by the electronic paper 40 can be more efficiently emitted to the outside of the housing 10. The anti-reflective film 75 is generally referred to as an antireflection coating (AR coating).

FIG. 10C schematically illustrates a cut end view, showing only a cut surface along line D-D in FIG. 1B, of a light-emitting module 122 according to a second modified example of the third embodiment. The light-emitting module 122 according to the second modified example of the third embodiment does not include a light-transmissive member 50, and a bottom surface 60a of the light guide member 60 extends to a bottom surface 25a of an adjustment member 25. The light-emitting module 122 according to the second modified example of the third embodiment includes the light-transmissive adhesive member 70 disposed between the light guide member 60 and the electronic paper 40 for bonding the electronic paper 40 and the light guide member 60. The material and the effect of the adhesive member 70 are as described above. The light-emitting module 122 according to the second modified example of the third embodiment may include the anti-reflective film 75 instead of the adhesive member 70.

The configurations, operations, and effects in the third embodiment, the first modified example of the third embodiment, and the second modified example of the third embodiment other than those described above are similar to those of the light-emitting module 100 according to the first embodiment.

### Fourth Embodiment

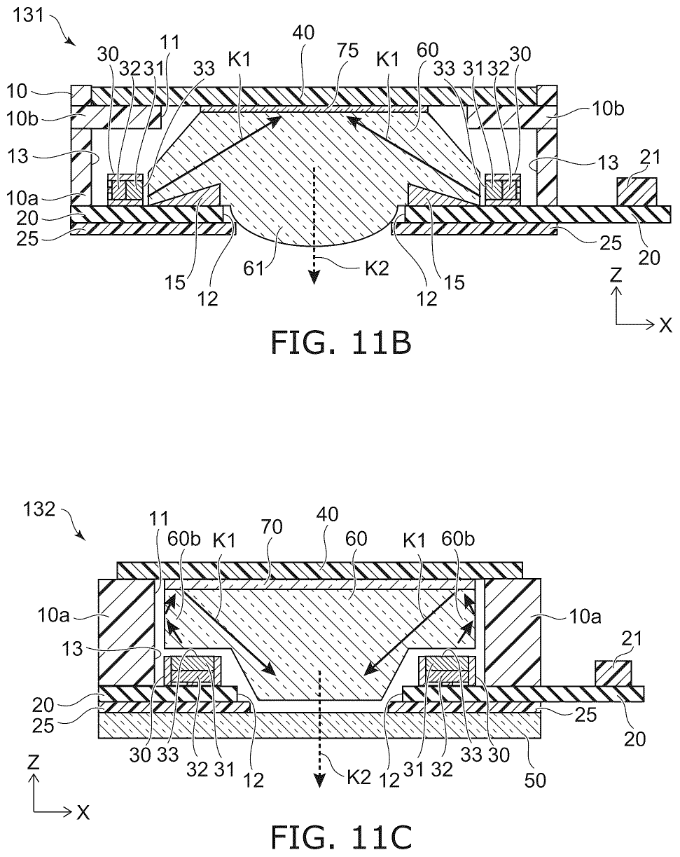

FIG. 11A schematically illustrates a cut end view, showing only a cut surface along line D-D in FIG. 1B, of a light-emitting module 130 according to the fourth embodiment. The light-emitting module 130 according to the fourth embodiment illustrated in FIG. 11A further includes a light guide member 60 disposed between a light-emitting device 30 and electronic paper 40 in a housing 10. The light guide member 60 includes a lens portion 61. On the other hand, the light guide member 60 may be constituted such that the lens portion 61 and a portion of the light guide member 60 other than the lens portion 61 are formed as separate bodies. The light-emitting module 130 according to the fourth embodiment includes a light-transmissive adhesive member 70 disposed between the light guide member 60 and the electronic paper 40 for bonding the electronic paper 40 and the light guide member 60.

In the light-emitting module 130 according to the fourth embodiment, provision of the light guide member 60 allows for obtaining an effect of reducing entry of foreign matter into the housing 10. Therefore, from the viewpoint of reducing the number of components, it is preferable that a light-transmissive member 50 be not provided, but the light-transmissive member 50 may be provided.

FIG. 11B schematically illustrates a cut end view, showing only a cut surface along line D-D in FIG. 1B, of a light-emitting module 131 according to a first modified example of the fourth embodiment taken along line D-D in FIG. 1B. The light-emitting module 131 according to the first modified example of the fourth embodiment illustrated in FIG. 11B further includes an anti-reflective film 75 that covers a surface of the light guide member 60 facing the electronic paper 40.

FIG. 11C schematically illustrates a cut end view, showing only a cut surface along line D-D in FIG. 1B, of a light-emitting module 132 according to a second modified example of the fourth embodiment taken along line D-D in FIG. 1B. In the light-emitting module 132 according to the second modified example of the fourth embodiment, an emission surface 33 of the light-emitting device 30 is disposed facing upward (+Z direction) and is disposed facing the electronic paper 40. That is, first light K1 is emitted upward (+Z direction), passes through and is reflected inside the light guide member 60, and is reflected by the electronic paper 40. Thus, second light K2 obtained as a result of reflection by the electronic paper 40 can be emitted to the outside of the housing 10. Both end portions 60b of the light guide member 60 are positioned above the light-emitting device 30 (+Z side) and reflect the first light K1 inside the light guide member 60. With this configuration, the first light K1 emitted toward a side portion 10a side of the housing 10 can be reflected by both the end portions 60b of the light guide member 60 to a center side of the housing 10 in FIG. 11C as indicated by arrows illustrated in FIG. 11C, and the emission efficiency of the second light K2 can be improved. The light-emitting module 132 according to the second modified example of the fourth embodiment further includes a light-transmissive member 50. The electronic paper 40 may be supported by the side portion 10a of the housing 10. The light-emitting module 132 according to the second modified example of the fourth embodiment illustrated in FIG. 11C further includes an adhesive member 70 or an anti-reflective film 75 that covers a surface of the light guide member 60 facing the electronic paper 40. Although FIG. 11C illustrates that the light-emitting module 132 according to the second modified example of the fourth embodiment includes the adhesive member 70, the light-emitting module 132 may include the anti-reflective film 75 instead of the adhesive member 70.

The configurations, operations, and effects in the fourth embodiment, the first modified example of the fourth embodiment, and the second modified example of the fourth embodiment other than those described above are similar to those of the light-emitting module 100 according to the first embodiment.

### Fifth Embodiment

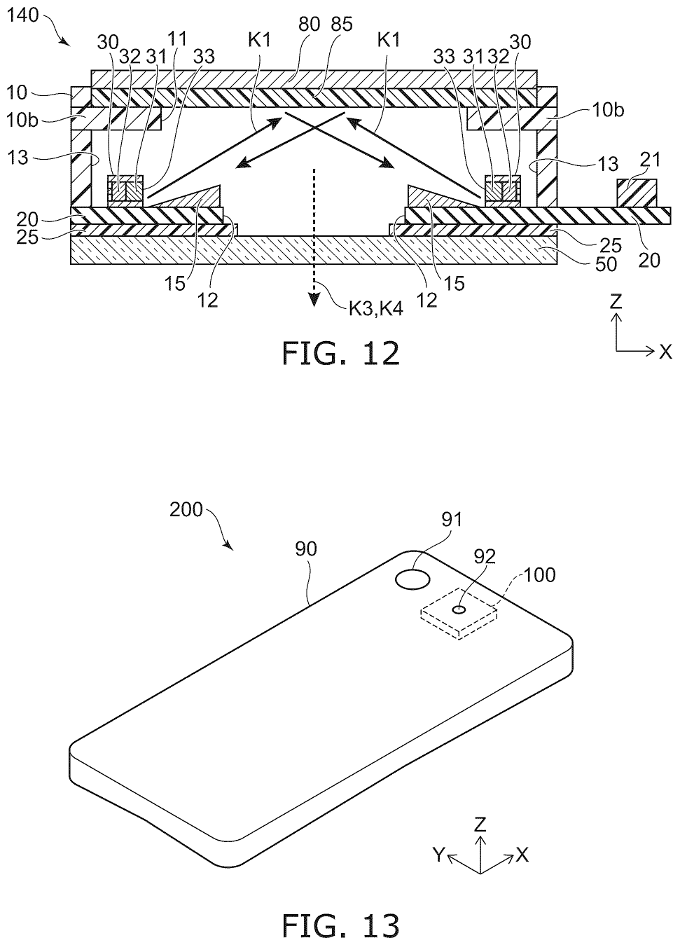

FIG. 12 schematically illustrates a cut end view, showing only a cut surface along line D-D in FIG. 1B, of a light-emitting module 140 according to the fifth embodiment taken along line D-D in FIG. 1B. The light-emitting module 140 according to the fifth embodiment illustrated in FIG. 12 includes a reflection plate 80 and a dimming mirror 85 instead of electronic paper 40. As illustrated in FIG. 12, the light-emitting module 140 according to the fifth embodiment includes a housing 10 having a first opening 11 and a second opening 12 provided on the side opposite the first opening 11, a light-emitting device 30 disposed at a position surrounded by the housing 10 and emitting first light K1, the dimming mirror 85 covering the first opening 11, and the reflection plate 80 provided above the dimming mirror 85. In the light-emitting module 140 according to the fifth embodiment, the dimming mirror 85 and the reflection plate 80 are provided on the upper side (+Z side) of the housing 10 so as to cover the first opening 11. The reflection plate 80 is formed of a material made of resin, metal, or a combination thereof.

Examples of the dimming mirror 85 include a dimming mirror that operates, for example, by an electrochromic system using electricity, and may become transparent, semi-transparent, and non-transparent. A known configuration is used for the dimming mirror 85. For example, a transparent base material, ITO, H_{X}WO₃, TaO₅, Al, Pd, and an Mg—Ni alloy are sequentially laminated. In the case of the above-described configuration, the dimming mirror 85 is in a mirror state (non-transparent) that reflects the first light K1. This state is referred to as a third state. When a voltage is applied to this configuration, H_{X}WO₃ is oxidized and becomes WO₃, a metallic Mg—Ni alloy is reduced and becomes a non-metallic Mg—Ni alloy hydroxide, and the dimming mirror 85 becomes transparent. This state is referred to as a fourth state. These reactions occur reversibly. The dimming mirror 85 is switchable between a third state in which non-transparent white appears when the light-emitting device 30 is turned on and a fourth state in which the color becomes transparent when the light-emitting device 30 is turned off. Once achieved, A changed state is maintained even when supply of electricity is stopped.

In the third state, the dimming mirror 85 reflects the first light K1 emitted from the light-emitting device 30 to allow third light K3 to travel to the outside of the housing 10 through the second opening 12. On the other hand, in the fourth state, the reflection plate 80 reflects the first light K1 emitted from the light-emitting device 30 to allow fourth light K4 to travel to the outside of the housing 10 through the second opening 12. The third light K3 refers to light reflected by the dimming mirror 85, and the fourth light K4 refers to light reflected by the reflection plate 80.

In the third state and the fourth state, the dimming mirror 85 is visually recognizable from the outside of the housing 10 through the second opening 12. Because the dimming mirror 85 is transparent in the fourth state as described above, the reflection plate 80 is visually recognizable from the outside of the housing 10 through the second opening 12.

In the fourth state in which the dimming mirror 85 becomes transparent when the light-emitting device 30 is turned off, in a case in which the light-emitting module 140 is, for example, used for a mobile device such as a smartphone or a tablet, in the fourth state in which the dimming mirror 85 becomes transparent when the light-emitting device 30 is turned off, an appearance of the light-emitting portion such as a flash is made less conspicuous by making a color of the reflection plate 80 match an appearance color of the mobile device.

According to the light-emitting module 140 according to the fifth embodiment described above, the appearance of the light-emitting portion such as a flash can be made less conspicuous.

The reflection plate 80 and the dimming mirror 85 may be curved in a convex shape in a direction from the second opening 12 toward the first opening 11. With this configuration, the first light K1 from the light-emitting device 30 can be efficiently reflected by the dimming mirror 85, and the third light K3 and the fourth light K4 can be emitted to the outside of the housing 10. The electronic paper 40 of the first embodiment, the second embodiment, the third embodiment, and the fourth embodiment can be replaced with the reflection plate 80 and the dimming mirror 85.

### 2. Mobile Device

FIG. 13 schematically illustrates a perspective view of a mobile device 200 according to the embodiments. The mobile device 200 is a smartphone, a tablet, or the like as illustrated in FIG. 13. As illustrated in FIG. 13, the mobile device 200 according to the embodiments includes a case 90, the above-described light-emitting module 100, a window 92 of the light-emitting module 100, and a camera 91. The window 92 of the light-emitting module 100 is a hole provided so that second light K2 from the light-emitting module 100 can be propagated to the outside of the case 90.

As described above, a display unit 41 of electronic paper 40 in a second state having a second color and an outer surface of the case 90 preferably have similar colors or are color-matched to each other. For example, when the color of the display unit 41 of the electronic paper 40 in the second state having the second color is white, the color of the outer surface of the case 90 should also be white. In this way, the appearance of a light-emitting portion such as a flash can be made less conspicuous.

As described above, according to the embodiments, the light-emitting module 100 and the mobile device 200, which make the appearance of the light-emitting portion such as a flash look less conspicuous, enable color adjustment and light emission of various colors, and have high color rendering properties, can be provided.

Each of the above-described embodiments and modified examples is an example embodying the present invention, and the present invention is not limited to these embodiments and modified examples. For example, in each of the above-described embodiments and modified examples, those in which some of the components or steps are added, omitted, or changed are also included in the present invention. Each of the above-described embodiments and modified examples can be implemented in combination with each other.

The present invention may be used, for example, in a light source such as a flash or in a display device.

What is claimed is:

1. A light-emitting module, comprising:
a housing including a first opening;
a substrate including a second opening;
a light-emitting device disposed in the housing and configured to emit first light; and
electronic paper covering the first opening, wherein
at least a portion of second light, which is a reflective component of the first light reflected by the electronic paper, is emitted to outside of the housing through the second opening,
the electronic paper is switchable between a first state in which a first color appears when the light-emitting device is turned on and a second state in which a second color appears when the light-emitting device is turned off, and
in the first state and the second state, the electronic paper is visually recognizable from the outside of the housing through the second opening.

2. The light-emitting module according to claim 1, wherein the light-emitting device is not visually recognizable from the outside of the housing through the second opening.

3. The light-emitting module according to claim 1, wherein an inner surface of the housing comprises a first light-reflective member.

4. The light-emitting module according to claim 1, wherein
the light-emitting module includes, inside the housing, a reflector configured to reflect the first light, and
the reflector includes a second light-reflective member that is configured to reflect at least a portion of the first light toward the electronic paper, the second light-reflective member being disposed at a position facing an emission surface of the light-emitting device.

5. The light-emitting module according to claim 1, wherein the first color and the second color are selected from cyan, magenta, yellow, white, red, green, black, and mixed colors of two or more of these colors.

6. The light-emitting module according to claim 1, wherein the first color is white.

7. The light-emitting module according to claim 1, wherein the first color is different from the second color.

8. The light-emitting module according to claim 1, wherein the electronic paper is convexly curved in a direction from the second opening toward the first opening.

9. The light-emitting module according to claim 1, further comprising a light-transmissive member covering the second opening.

10. The light-emitting module according to claim 9, wherein the light-transmissive member comprises one or more lens portions.

11. The light-emitting module according to claim 10, wherein the one or more lens portions include a first lens portion that is convex toward the first opening.

12. The light-emitting module according to claim 9, wherein the light-transmissive member has a flat plate shape.

13. The light-emitting module according to claim 1, further comprising a light guide member disposed between the light-emitting device and the electronic paper.

14. The light-emitting module according to claim 13, further comprising a light-transmissive adhesive member disposed between the light guide member and the electronic paper.

15. The light-emitting module according to claim 13, further comprising an anti-reflective film covering a surface of the light guide member that faces the electronic paper.

16. The light-emitting module according to claim 13, wherein the light guide member comprises a lens portion.

17. The light-emitting module according to claim 1, wherein a plurality of the light-emitting devices are disposed around the second opening.

18. The light-emitting module according to claim 1, wherein the first light is white.

19. A mobile device, comprising:
a case; and
the light-emitting module according to claim 1, the light-emitting module being disposed in the case.

20. The mobile device according to claim 19, wherein a color of the electronic paper in the second state visually recognizable through the second opening and an outer surface of the case are color-matched to each other.
